(19) United States
(12) Patent Application Publication
(10) Pub. No.: US 2016/0003479 A1
(43) Pub. Date: Jan. 7, 2016

(54) PROCESS OF ASSEMBLING FUEL NOZZLE END COVER

(71) Applicant: GENERAL ELECTRIC COMPANY, Schenectady, NY (US)

(72) Inventors: Steven Charles WOODS, Easley, SC (US); Mark Carmine BELLINO, Greenville, SC (US)

(21) Appl. No.: 14/323,685

(22) Filed: Jul. 3, 2014

(51) Int. Cl. F23R 3/28; F02C 7/22

(52) U.S. Cl. CPC F23R 3/283; F02C 7/22; F05D 2230/60; F05D 2230/10; F05D 2230/232; F05D 2220/32; F23R 2900/00018

(57) ABSTRACT

A process of assembling a fuel nozzle end cover includes machining a base material of the fuel nozzle end cover, then positioning one or more ring inserts in contact with the base material, then welding the ring insert(s) to the base material to define one or more ledge features within the fuel nozzle end cover. The ring insert(s) have a net shape or near-net shape.

### FIELD OF THE INVENTION

The present invention is directed to processes of assembling fuel nozzle components having fuel nozzles. Most specifically, the present invention is directed to processes of assembling fuel nozzle end covers.

### BACKGROUND OF THE INVENTION

In general, gas turbines are being subjected to more demanding operation. Higher temperatures, harsher environments, use in more diverse environments, and extended duration of use result in challenges for gas turbines and their components. Extending the useful life of such components and improving capability for repair of such components can decrease costs associated with the gas turbines and can increase the operational aspects of the gas turbines.

Known end covers on fuel nozzles in gas turbines have an insert brazed into the end cover. Generally, such inserts have four braze joints securing the inserts within the end cover. These braze joints are subject to failure, for example, resulting in leaking proximal to the braze joints. Such braze joints can also suffer from a drawback of requiring frequent repair. Such repairs can be complex and expensive. In addition, the ability to perform such repairs may be limited.

A process of assembling a fuel nozzle end cover that shows improvements over the prior art would be desirable in the art.

### BRIEF DESCRIPTION OF THE INVENTION

In an embodiment, a process of assembling a fuel nozzle end cover includes machining a base material of the fuel nozzle end cover to define a cylindrical region, the cylindrical region including ports for fluid transport within the fuel nozzle end cover, then positioning a ring insert in contact with the base material within the cylindrical region in a position that permits the fluid transport through the ports, then welding the ring insert to the base material to define one or more ledge features within the fuel nozzle end cover in the position that permits the fluid transport through the ports. The ring insert has a net shape or near-net shape.

In another embodiment, a process of assembling a fuel nozzle end cover includes machining a body to form a ring insert and machining a base material of the fuel nozzle end cover, then positioning the ring insert in contact with the base material, then welding the ring insert to the base material to define one or more ledge features within the fuel nozzle end cover. The ring insert has a net shape or near-net shape.

In another embodiment, a process of assembling a fuel nozzle end cover includes machining a base material of the fuel nozzle end cover, then positioning a first ring insert in contact with the base material, then welding the first ring insert to the base material, then positioning a second ring insert in contact with the base material, then welding the second ring insert to the base material. The first ring insert and the second ring insert have net shapes or near-net shapes.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a cutaway section view of an exemplary fuel nozzle assembly having a fuel nozzle end cover and a fuel nozzle insert with the fuel nozzle insert shown in an inserted position, according to an embodiment of the disclosure.

FIG. 2 is a schematic section view of an exemplary fuel nozzle assembly having a fuel nozzle end cover and a fuel nozzle insert with the fuel nozzle insert shown in a removed position, according to an embodiment of the disclosure.

FIG. 3 is a perspective view of a non-segmented fuel nozzle ring insert, according to an embodiment of the disclosure.

FIG. 4 is a perspective view of a segmented fuel nozzle ring insert, according to an embodiment of the disclosure.

Wherever possible, the same reference numbers will be used throughout the drawings to represent the same parts.

### DETAILED DESCRIPTION OF THE INVENTION

Provided are processes of assembling a fuel nozzle end cover, for example, for a fuel nozzle in a turbine system. Embodiments of the present disclosure, in comparison to similar concepts failing to include one or more of the features disclosed herein, permit better sealing within fuel nozzle end covers, permit increased operational efficiency of turbine systems using fuel nozzles, reduce or eliminate weld spatter within fuel nozzle end covers, overcome challenges presented by brazing within fuel nozzle end covers, permit use of fuel nozzle end covers with otherwise incompatible fuel nozzle inserts, or a combination thereof.

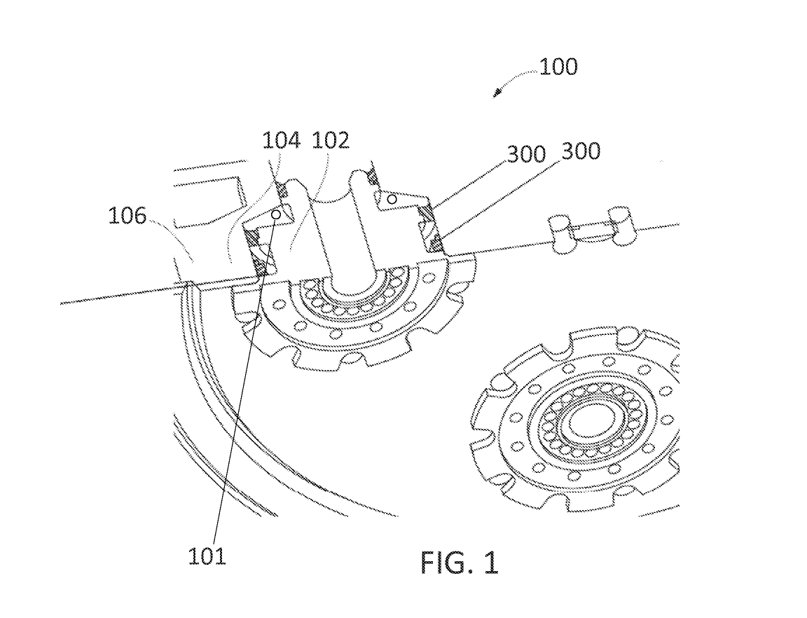

Referring to FIG. 1, a process of assembling a fuel nozzle end cover 104 includes machining a base material 106, positioning a ring insert 300 in contact with the base material 106, and welding the ring insert 300 to the base material 106. As used herein, the term “ring” is broadly used to describe any suitable annular structure, which is capable of being continuous and non-segmented, as shown in FIG. 3, or not continuous and segmented as shown in FIG. 4. The ring insert 300 has a net shape or a near-net shape. As used herein, “net shape” refers to having a final geometry that is not machined, peened, or otherwise structurally modified in any manner. As used herein, “near-net shape” refers to having a geometry that is not substantially modified, for example, by machining Those skilled in the art will understand that being net shaped and near-net shaped does not preclude surface treatments or coatings.

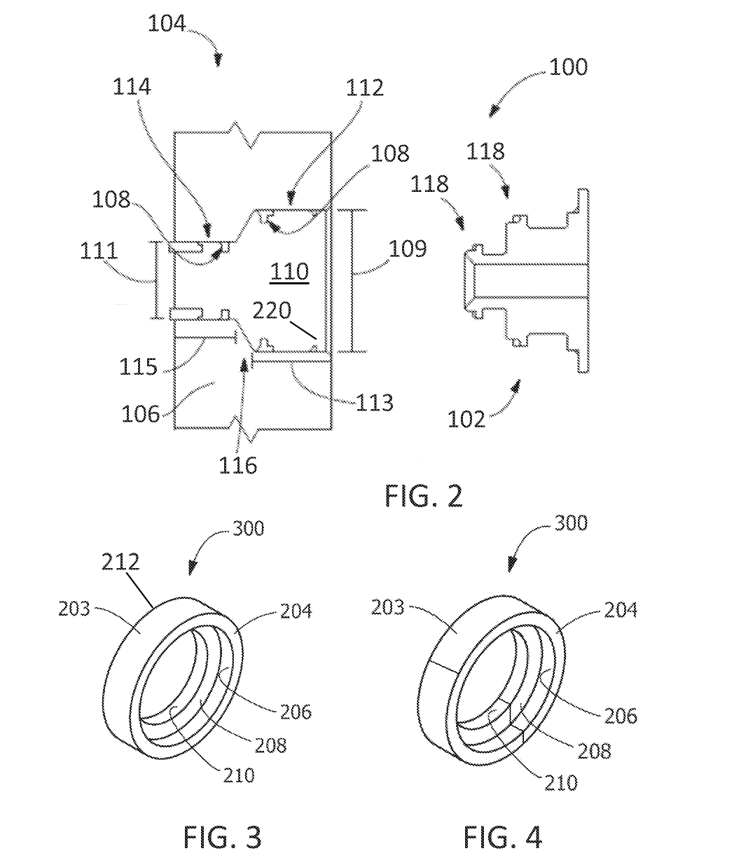

Referring to FIG. 2, the machining of the base material 106 defines a cavity 110 within the fuel nozzle end cover 104. The machining is within a fabrication process or a repair process, for example, removing features/material (not shown) having a different geometry from the ring insert 300 and/or removing build-up (not shown) from operation. The cavity 110 includes any suitable geometry. For example, in one embodiment, the cavity 110 includes a first cylindrical portion 112 separated from a second cylindrical portion 114 by one or more ledge features 108 corresponding with the ring insert(s) 300. In this embodiment, the first cylindrical portion 112 has a first diameter 109 (for example, between about 3 inches and about 5 inches) that is larger than a second diameter 111 (for example, less than about 3 inches) of the second cylindrical portion 114, the first diameter 109 differing from the second diameter 111. In one embodiment, the first cylindrical portion 112 has a first depth 113 (for example, between about 1 inch and about 2 inches) and the second cylindrical portion 114 has a second depth 115 (for example, greater than about 2 inches), the first depth differing from the second depth. In a further embodiment, a frustoconical portion 116 separates the first cylindrical portion 112 and the second cylindrical portion 114.

Referring again to FIG. 1, the ring inserts 300 are positioned to permit fluid transport within the fuel nozzle end cover 104 through ports 101 positioned within the fuel nozzle assembly 100, to separate and/or seal portions of the cavity 110, and/or to permit repeated insertion and removal of a fuel nozzle insert 102 when assembling and/or repairing a fuel nozzle 100, for example, within a gas turbine system. In one embodiment, the ring inserts 300 are positioned within each of the first cylindrical portion 112 and the second cylindrical portion 114. In other embodiments, only one of the ring inserts 300 is positioned in each of the first cylindrical portion 112 and the second cylindrical portion 114.

Referring to FIG. 3, prior to being inserted into the cavity 110, the ring inserts 300 are machined from a base (not shown) to any suitable predetermined geometry having the ledge features 108 with the net shape or the near-net shape. The ledge features 108 (see FIG. 2) and the ring inserts 300 (see FIG. 3) are machined and/or formed outside of the fuel nozzle end cover 104. The ledge features 108 are arranged and disposed to facilitate removable securing of the fuel nozzle insert 102 to the fuel nozzle end cover 104 in the cavity 110 (for example, mechanically, by brazing, or by welding, such as, laser beam welding, electron beam welding, friction welding, gas tungsten arc welding, gas metal arc welding, or combinations thereof). The ledge features 108 extend into the cavity 110 forming concentric rings corresponding to protrusions 118 on the fuel nozzle insert 102. The protrusions 118 each have a geometry corresponding to the geometry of the ledge features 108, thereby permitting the fuel nozzle insert 102 in a predetermined position within the fuel nozzle end cover 104 (for example, in one embodiment, the predetermined position is defined by the geometry of the fuel nozzle insert 102, the fuel nozzle end cover 104, the ledge features 108 and/or the ring inserts 300).

In one embodiment, at least one of the ring inserts 300 has a stepped geometry. In a further embodiment, at least one of the ring inserts 300 includes a first surface 203 to be positioned to abut the base material 106 when secured, a second surface 204 extending in a direction substantially perpendicular to the first surface 203 (for example, to be positioned to extend into the cavity 110), a third surface 206 extending in a direction substantially perpendicular to the second surface 204 (for example, to be positioned parallel to the first surface 203), a fourth surface 208 extending in a direction substantially perpendicular to the third surface 206 (for example, to be positioned to extend into the cavity 110), a fifth surface 210 extending in a direction substantially perpendicular to the fourth surface 208 (for example, to be positioned parallel to the first surface 203), and a sixth surface 212 extending in a direction substantially perpendicular to the fifth surface 210 when secured (for example, to be positioned in a direction extending toward the base material 106). In one embodiment, at least one of the ring inserts 300 includes a geometry that is not stepped, for example, having at least one of the ledge features 108 with a sloping portion 220 (see FIG. 2).

According to the present disclosure, the ring inserts 300 are secured to the base material 106 by welding. The securing of the ring inserts 300 to the base material 106 results in a predetermined microstructure (not shown) based upon the welding process utilized. The welding permits repeated insertion and removal of the insert 102 into the fuel nozzle end cover 104. For example, in one embodiment, the insert 102 is capable of being removed from the fuel nozzle end cover 104 with little or no damage to the fuel nozzle assembly 100 at least a predetermined number of times, for example, more than three times, more than four times, more than five times, or more than ten times. The welding is by gas tungsten arc welding, gas metal arc welding, cold metal transfer, and combinations thereof and/or by beam welding, friction welding, and combinations thereof. As will be appreciated by those skilled in the art, other embodiments include characteristics distinguishing from techniques using brazing.

The ring insert(s) 300 is/are welded to permit fluid transport within the fuel nozzle end cover 104 through feed holes or ports 101 positioned within the fuel nozzle assembly 100 (see FIG. 1). The ports 101 are positioned within the base material of the fuel nozzle end cover 104, for example, with one, two, three, four, or more being positioned in a concentric arrangement between one or more regions of the cavity 110 defined by the ring inserts 300. Prior to the welding, in one embodiment, the ports 101 are masked, for example, by a technique selected from the group consisting of positioning one or more copper chill blocks, positioning sheet metal, ceramic masking, and combinations thereof. In a further embodiment, the masking prevents weld spatter from being deposited within the fuel nozzle end cover 104, thereby resulting in the fuel nozzle end cover 104 being devoid of weld spatter.

The material within the ring inserts 300 and the base material 106 are the same materials, substantially the same materials, or different materials. Such materials include any suitable metal or metallic composition (for example, stainless steel or stainless steel variations). In one embodiment, the ring inserts 300 and/or the base material 106 include austenitic stainless steel. In another embodiment, the ring inserts 300 and/or the base material 106 include ferritic stainless steel. In another embodiment, the ring inserts 300 and/or the base material 106 include martensitic stainless steel. In further embodiments, the ring inserts 300 include austenitic stainless steel, ferritic stainless steel, or martensitic stainless steel and the base material 106 includes a different stainless steel selected from the group of austenitic stainless steel, ferritic stainless steel, and martensitic stainless steel. In one embodiment, the material of the ring inserts 300 includes an equal or greater ductility in comparison to materials used for brazing and/or than the base material 106 would have when secured by welding, such as, beam welding (such as laser and/or electron beam), friction welding, (such as tungsten inert gas welding), and/or gas metal arc welding (such as metal inert gas welding).

While the invention has been described with reference to one or more embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In addition, all numerical values identified in the detailed description shall be interpreted as though the precise and approximate values are both expressly identified.

What is claimed is:

1. A process of assembling a fuel nozzle end cover, the process comprising:
machining a base material of the fuel nozzle end cover to define a cylindrical region, the cylindrical region including ports for fluid transport within the fuel nozzle end cover; then
positioning a ring insert in contact with the base material within the cylindrical region in a position that permits the fluid transport through the ports; then
welding the ring insert to the base material to define one or more ledge features within the fuel nozzle end cover in the position that permits the fluid transport through the ports;
wherein the ring insert has a net shape or near-net shape.

2. The process of claim 1, further comprising masking the ports.

3. The process of claim 2, wherein the masking includes a technique selected from the group consisting of positioning one or more copper chill blocks, positioning sheet metal, ceramic masking, and combinations thereof.

4. The process of claim 1, wherein the welding is selected from the group consisting of gas tungsten arc welding, gas metal arc welding, cold metal transfer, and combinations thereof.

5. The process of claim 1, wherein the welding is selected from the group consisting of beam welding, friction welding, and combinations thereof.

6. The process of claim 1, further comprising machining a body to form the ring insert prior to the welding of the ring insert.

7. The process of claim 1, wherein the process is devoid of generating weld spatter within the fuel nozzle end cover.

8. The process of claim 1, further comprising positioning and welding a second ring insert in the fuel nozzle end cover.

9. The process of claim 8, further comprising positioning and welding a third ring insert in the fuel nozzle end cover.

10. The process of claim 9, further comprising positioning and welding a fourth ring insert in the fuel nozzle end cover.

11. The process of claim 10, further comprising positioning and welding a fifth ring insert in the fuel nozzle end cover.

12. The process of claim 1, further comprising removably securing a fuel nozzle insert to the fuel nozzle end cover.

13. The process of claim 1, wherein the machining of the base material includes removing features from the fuel nozzle end cover as a repair process.

14. The process of claim 1, wherein the base material and the ring insert are different materials.

15. The process of claim 1, wherein the base material and the ring insert are substantially identical materials.

16. The process of claim 1, wherein the ring insert seals the ports in a first portion of the cylindrical region from the ports in a second portion of the cylindrical region.

17. The process of claim 1, wherein the ring insert includes a plurality of segmented portions.

18. The process of claim 1, wherein the ring insert includes a single non-segmented annular structure.

19. A process of assembling a fuel nozzle end cover, the process comprising:
machining a body to form a ring insert and machining a base material of the fuel nozzle end cover; then
positioning the ring insert in contact with the base material; then
welding the ring insert to the base material to define one or more ledge features within the fuel nozzle end cover;
wherein the ring insert has a net shape or near-net shape.

20. A process of assembling a fuel nozzle end cover, the process comprising:
machining a base material of the fuel nozzle end cover; then
positioning a first ring insert in contact with the base material; then
welding the first ring insert to the base material; then
positioning a second ring insert in contact with the base material; then
welding the second ring insert to the base material;
wherein the first ring insert and the second ring insert have net shapes or near-net shapes.
